(19) United States
(12) Patent Application Publication
(10) Pub. No.: US 2024/0328492 A1
(43) Pub. Date: Oct. 3, 2024

(54) STRAIGHT-LINE AND PLANAR MECHANISM AND MACHINES

(71) Applicant: Andrew Karl Knorr, Traralgon (AU)

(72) Inventor: Andrew Karl Knorr, Traralgon (AU)

(21) Appl. No.: 18/579,518

(22) PCT Filed: Jul. 19, 2022
(86) PCT No.: PCT/AU2022/050764

§ 371 Date: Jan. 16, 2024

(30) Foreign Application Priority Data
Jul. 20, 2021 (AU) 2021902239

(51) Int. Cl. F16H 37/12

(52) U.S. Cl. CPC F16H 37/124

(57) ABSTRACT

The present invention provides for a mechanism that allows for the creation of devices and machines that function to move, position and hold relative to straight lines and parallel planes. The functions are enabled without the use of sliding surfaces or linear bearings, and, in the case of robotics, without the use of complex calculations and control systems. The mechanism of the present invention incorporates a four bar planar parallelogram linkage with the ground link fitted with at least one additional coplanar pivotable link. The additional link and one of the four bar linkage's rocker links are fitted with circular means. Crossed flexible pulling and holding means are applied in a way so that, when the additional pivotable link is moved in a direction, the connected rocker link moves in the opposite direction, and, when the additional planar pivotable link is held in a certain position, the connected rocker link is held in the same relative position. The further rocker link and the coupler of the planar four bar linkage either move or are held accordingly. The described mechanism is added to and mounted in various ways to enable the described functions.

### TECHNICAL FIELD

The present invention relates to improved and simplified devices and machines to move, position and hold relative to straight lines and parallel planes.

### BACKGROUND OF THE INVENTION

Current machines and mechanisms for moving, positioning and holding relative to straight lines and parallel planes use slides, linear bearings and complex calculating and positioning technology.

Industrial type robot arms are not naturally suited to moving objects and loads in straight lines and in parallel planes. To achieve these ends complex computer calculations need to be carried out with calculations sent to controllers and positioners. If objects are irregular and of different sizes complexity and difficulty increases.

In large, long stroke engines such as some marine diesels crossheads are included between the piston and the crankshaft to create a straight path for the piston rod. The crosshead uses slides to create the straight path line. These slides are difficult and expensive to make, are heavy, and require constant lubrication.

At another level, platform lifts such as scissor lifts move objects and loads in parallel planes. These machines use scissor type mechanisms and slides to accommodate the changing width of the scissors or pantographs as the work platform travels upwards. The changing width can lead to strength and stability issues as height increases and the support centre of the scissor mechanism shifts more to one side of the work platform. These identified issues and problems were attempted to be overcome in a parallel plane lifting and moving device disclosed in a patent application US2002139618 A1.

The present inventor in his previous patent application PCT/AU2019/050309 describes a mechanism he calls a reverse arm mechanism. This mechanism is also disclosed in US2002139618 A1.

The present invention is made for the purpose of improving the stability, strength, utility, versatility, efficiency and efficacy of devices and systems discussed prior and disclosed in the cited applications above.

At the time of the present invention the cited methods and mechanisms are not commonly known or used.

### SUMMARY OF THE INVENTION

The basic embodiment of the mechanism of the present invention incorporates a parallelogram four bar linkage. Parallelogram four bar linkages have inherent stability and consistency and are used in a range of applications and industries. The current invention increases the usability of this type of four bar linkage and enables new types of mechanisms, devices, apparatuses and machines.

Elements of the invention are described relative to terms commonly used relative to planar four bar linkages. The mechanism of the present invention incorporates a four bar planar parallelogram linkage. The four bar linkage is comprised of arms or links with a base or ground link, two rocker links and a coupler link.

In the present invention the ground link is fitted with at least one additional coplanar pivotable link. All links are coplanar or travel in planes that are parallel to each other. The ground link may be extended to accommodate the extra link or links as necessary. The additional pivotable link is a rocker link and is called the additional rocker link and may itself be part of an additional four bar linkage The additional rocker link and one of the four bar linkage's rocker links are fitted with circular attachments concentric with the links' pivot. The four bar linkage rocker link that is fitted with the circular means and that is also connected with the pulling and holding means is called the connected rocker link. The other linkage rocker link that is not the connected rocker link is called the other rocker link. A link is defined as being a member, arm or bar with two pivot points and pivots. Rocker links in a particular embodiment all have the same distance between pivots. The ground link and the coupler link that are part of one linkage have the same distance between their pivots. A link that is connected at its pivot at one end and not at its other end has a free end and a free end pivot.

The circular attachments are fitted with crossed flexible pulling and holding means. The crossed flexible pulling and holding means sit upon the circumference of the circular means. The crossed pulling and holding means cause the additional rocker link and the connected rocker link to be held and moved in a synchronised manner. The connection of the circular means by the crossed pulling and holdings means causes the connected rocker link to be held in a particular position when the additional pivot link is held, and, to move the connected rocker link in the opposite direction of the additional rocker link when the additional pivot link is moved in a particular direction. The other rocker link and the coupler of the planar four bar linkage either move or are held accordingly. As it is a parallelogram four bar linkage, the other rocker link always remains parallel to the connected rocker link and the coupler link remains parallel to the ground link.

The additional pivot link, the pulling and holding means and the connected rocker link are adjusted and connected so that the opposed angles formed between the rocker links and the ground links are congruent and equal. When the opposed angles are 90 degrees all links are parallel. At all times of travel, and in all the positions moved to, the centre points of the rocker link pivots will form a straight line with the centre point of the free end pivot of the additional rocker link.

Movement generated by the basic embodiment of the invention is symmetrical around the axis or point that accords with the crossing point of the crossed pulling and holding means. The crossed pulling and hold means component of the basic embodiment reverses the direction of the travel of the links and holds the angle of the links equal.

The described mechanism is added to and mounted in various ways to enable the mechanism and machine embodiments and functions described in following sections. The basic function is to enable and facilitate travel and movement in straight lines and along parallel planes.

### BRIEF DESCRIPTION OF THE DRAWINGS

FIG. 1a represents a side elevation of the basic mechanism of the present invention.

FIG. 1b represents a side elevation of an alternative configuration of the base mechanism.

FIGS. 2a represents a side elevation of a device that incorporates a mechanism of the present invention with the moving part of the device in a central hanging position.

FIGS. 2b represents the side elevation of the device shown in 2a in which the moving part of the device is shown at the limit of its travel.

FIG. 2c represents the side elevation of an apparatus or machine that incorporates two connected devices shown FIG. 2a.

FIG. 2d represents the side elevation an alternative embodiment of the device shown in FIGS. 2.

FIG. 3 represents the side elevation of a device that enables and creates straight line point movement.

FIG. 4 represents the side elevation of a device that enables and creates straight line and parallel plane movement.

FIG. 5a represents the side elevation of further device that enables and creates straight line and parallel plane movement.

FIG. 5b represents the side elevation of the device shown in FIG. 5b with the device being able to be used in multiples as shown.

FIG. 6 represents examples of extensions and variation that can be made relative to earlier embodiments shown.

FIG. 7 represents example uses for embodiments of the invention with the embodiment relating to the embodiment shown in FIGS. 2.

The preceding diagrams and figures are not intended to limit embodiments and applications of the invention. Mechanisms that accord with the present invention can be used in various configurations and orientations and can incorporate and utilise and provide for functions, uses and movements not shown in drawings.

Where a link is shown in a drawing as a single link it can represent multiple links or layers of links. The same applies to circular means and flexible pulling and holding means. Pivot points can also be construed as having depth so as to support layers or multiples.

Figures and diagrams are not to a scale and the relative sizes of elements shown may not be the relative sizes in constructed embodiments.

### DETAILED DESCRIPTION OF EMBODIMENTS

The present invention provides a base mechanism for incorporation in further apparatuses and machines which produce and utilise straight line and parallel plane motion.

This description is made using terms commonly used relative to planar parallelogram four bar linkages including the terms the base or ground link, the two rocker links and the coupler link. A link is defined as an arm, member or bar with two pivots or pivot point joints or joining means. Relative to a described embodiment, rocker links have equal distances or lengths between each pivot, and ground and coupler links similarly have an equal distance or length between their pivots. An added link can move relative to its pivot in the same plane or in a plane parallel to a plane or planes in which the four bar parallel linkage moves.

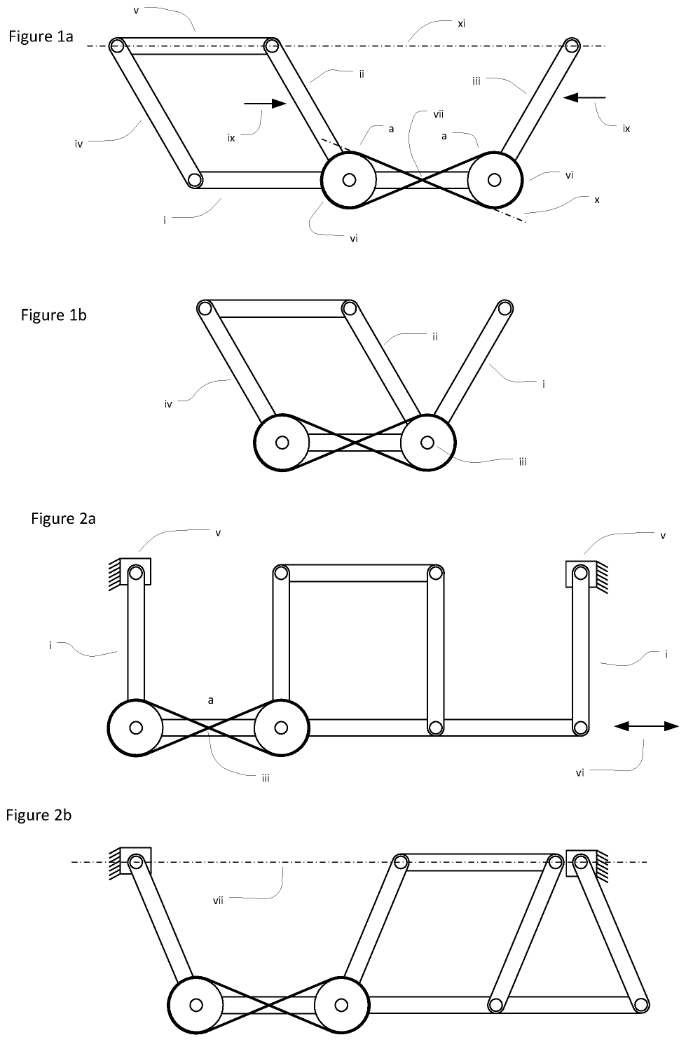

FIG. 1a represents the base mechanism and details its elements with (a) being an extended ground link, (ii) the connected rocker link and one of the linkage rocker links, (iii) the additional rocker link, (iv) the other rocker link and one of the linkage rocker links, (v) the coupler link, (vi) the circular means connected concentrically with the pivot points of the connected rocker link and the additional rocker link, (vii) the crossed pulling and holding means connecting the circular means, (a) and (a) the generally equal and congruent opposed angles formed between the ground link and the connected rocker link and the additional rocker link, with (ix) being arrows that represent the opposite directions taken by a rocker link when one rocker link is moved in the direction shown by an arrow, with line (x) representing an opposite tangent to the two circular means and with (xi) being a straight line passing through the centre points of the rocker link pivots and the centre point of the free end pivot of the additional rocker link.

FIG. 1b represents a side elevation of an alternative configuration of the base mechanism in which the additional rocker link (it) has the same pivot point as the other rocker link (ii) with the additional rocker link pivot being concentric with the other rocker link pivot (iii) and with the connected rocker link being (iv).

FIGS. 1a and 1b provide a representation of the base mechanism and details of its elements. The basic embodiment includes a four bar parallel linkage with at least one additional rocker link added to the ground link. An additional rocker link has two pivots. The pivots of the additional rocker links have the same spacing and distance between them as the distance between the pivots of the other rocker links that form the mechanism.

The additional rocker link has a circular means attached. The circular means is concentric to the additional rocker link pivot point that connects with the ground link. One of the four bar linkage's rocker links, the connected rocker link, is also fitted with circular means concentric with the rocker link's ground link pivot. The circular means are fitted with crossed pulling and holding means that connect the rocker links fitted with circular means. The crossed pulling and holding means sit upon and contact the circumferences of the circular means. The pulling and holding means follow a generally tangential path between the circular means and maintain a generally constant tangential distance throughout the movement of the mechanism.

Movement generated by the mechanism is symmetrical around the axis or point that accords with the crossing point of the crossed pulling and holding means.

The crossed pulling and holding means synchronise the movement of the two connected links. The crossed pulling and holding means and the links are adjusted so that the connected rocker links form opposing angles that are congruent angles relative to the ground link. The crossed pulling and holding means hold both connected rocker links in a certain position when one of the links is held in a position. The crossed pulling and holding means move one connected rocker link in a direction when the other link is moved in an opposite direction. When one link is moved, all links of the mechanism move, and when one link is held, all links are held in the same relative position. The centre points of the coupler link pivots remain in line with the centre of the free end of the additional link throughout the range of movement of the mechanism. This path of movement can only happen when the additional rocker link and the crossed pulling and holding means are adjusted correctly relative to the ground link and the other connected rocker link.

The base mechanism can have an extended ground link with an added pivot point at a chosen position on the ground link for the additional pivot rocker link, as shown in FIG. 1a, or can have the additional pivot rocker link fitted concentrically with a rocker link as shown in FIG. 1b.

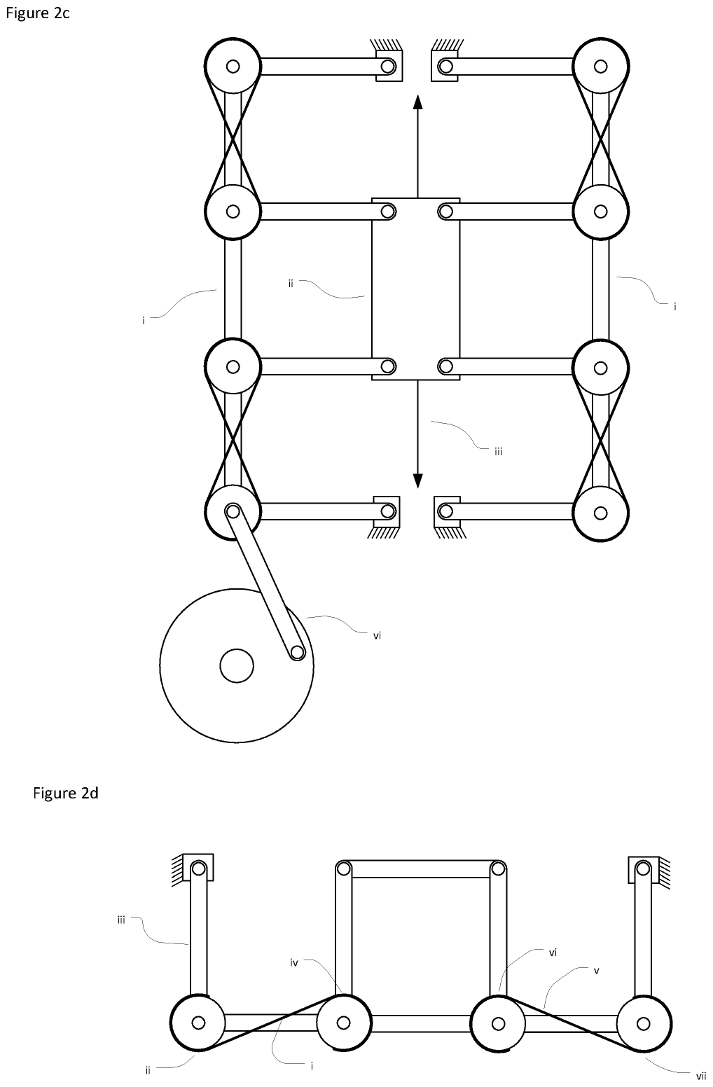

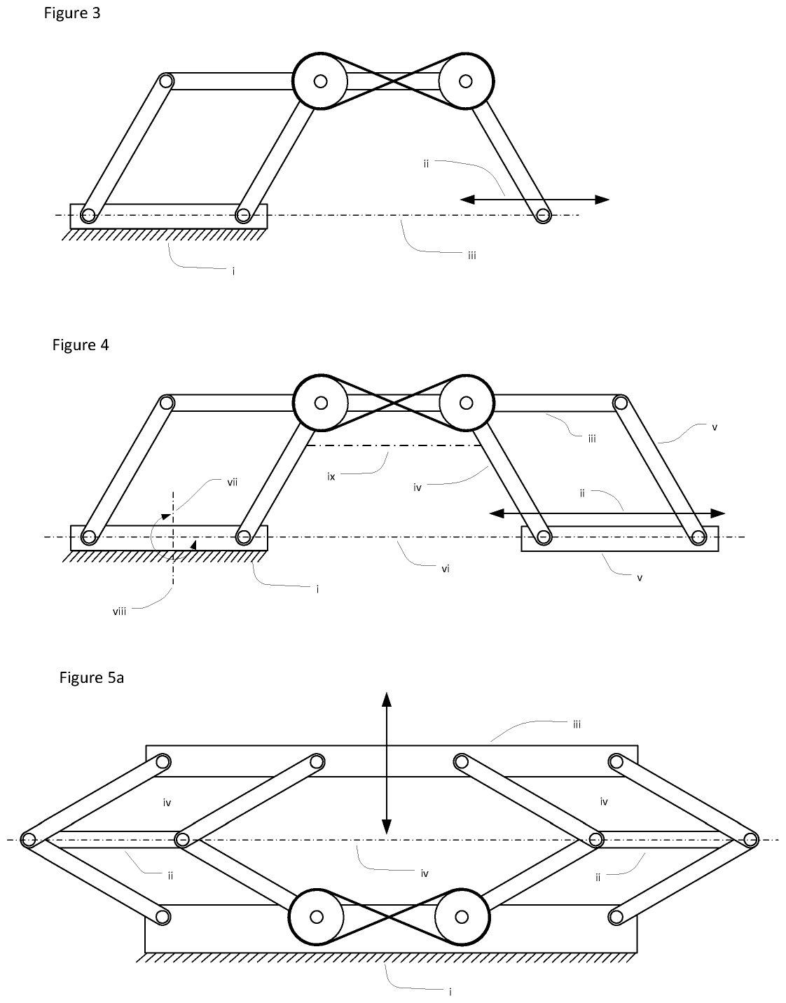

FIGS. 2a and 2b represent an embodiment and application and device in which two additional rocker links and pivots (i) are added to the extended ground link (ii) on either side of the four bar linkage at a distance (a) from the closest linkage rocker link, with circular means and pulling and holding means (iii) connected to one or both additional rocker links and their adjoining or close rocker links to form the connected rocker links, and with the additional rocker links supported at their pivots at hatched points (v) to allow the ground link to swing freely in the direction shown by arrow (vi) and with distance between hatched pivot points (v) and the coupler link pivot points being equal to (a) when all rocker links are parallel, and with 2b showing the ground link swung or moved to the right, the resulting position of the four bar linkage, and the travel of the coupler link along the same plane and along the same straight line as represented by broken line (vii) that passes through the centres of the additional rocker links supported pivots and the rocker linkage pivots and with 2a representing the central hanging position cause by gravity and 2b representing the extremes of movement of travel from the central position.

FIGS. 2a and 2b represent an embodiment and application and device which incorporates a base mechanism. The embodiment provides for a work platform that travels in a straight line and in a parallel plane between two support points. The embodiment provides for low friction and low energy input movement. Two additional rocker links and pivots are added to an extended ground link on either side of the four bar linkage. Circular means and crossed pulling and holding means are connected to one or both additional rocker links and their adjoining rocker links to form the connected rocker links.

The additional rocker links are supported at their free end pivots so as to allow the rocker links and the ground links to swing freely between the supports, with 2b showing the ground link swung or moved to the right, the resulting position of the four bar linkage with one additional rocker link held parallel to the linkage rockers, and the travel of the coupler link work platform along the same plane and along the same straight line that passes through the supported free end pivot centres and the centres of the moveable rocker link pivots.

Further additional rocker links could be added to the extended ground link and be used to provide additional stability and support for the ground link and the apparatus.

In this embodiment the rocker links and ground link can act as a pendulum and the ground link will travel less distance than the coupler work head distance travelled. The pendulum effect can be used to store gravitational energy relative to stop and start positions, reducing energy requirements for stopping and starting movements or to be used for other purposes.

While the diagrams show the apparatus connected with one crossed pulling and holding means either side of the central rocker four linkage, the apparatus functions the same with two connected crossed pulling and holding means mounted and fitted at both sides of the central four bar linkage.

Relative to the description of a workhead travelling in a plane, or the plane of travel of the workhead, and as relates to FIGS. 2a and 2b and other figures and descriptions, the said plane includes the centre points of the two pivots of the workhead as shown in a diagram, and centre points along the extensions of the pivots that would occur in a constructed embodiment.

FIG. 2c represents an example related embodiment to that shown in FIGS. 2a and 2b with two of the devices used in an opposing configuration with the ground links (i) orientated in the vertical position and with the coupler link (ii) made common to the two mechanisms, with the arrow (iii) showing the straight line vertical motion, and with a connecting rod and flywheel or crankshaft (iv) connected to a ground link.

FIG. 2c represents an example related embodiment to that shown in FIGS. 2a and 2b with two described mechanisms used in an opposing configuration with the ground links orientated in a vertical position and with the coupler link made common to the two mechanisms to form the work head.

In this configuration straight line and parallel plane motion is vertical. Such a mechanism configuration, by way of example relative to all applicable configurations, can have a connecting rod and crankshaft or flywheel fitted. The connecting rod can be fitted at or near to the ground link to reduce the travel of the connecting rod compared to if the connecting rod was connected to or near the coupler link work head. In this configuration the weight and size of the crankshaft and flywheel can be reduced relative to the stroke and length of travel of the coupler link work head. Rocker links can be extended as required and fitted with counterweights to counter the weight of the work head assembly if and as required. If the opposing configuration shown was rotated so that the workhead was in the horizontal orientation, the pendulum effect earlier described would be minimised or negated.

FIG. 2d represents an alternative embodiment in which the crossed pulling and holding means are connected with one flexible pulling and holding means (i) crossing from one side of circular means (ii) connected to the additional rocker link (iii) to the opposite side of a circular means (iv) connected to the adjoining rocker link and with another flexible pulling and holding means (v) connected to the same side (vi) of the other adjoining connected circular means with that pulling and holding means crossing to the opposite side (vii) of the circular means connected to the other additional rocker link.

FIG. 2d represents an alternative embodiment in which circular means are attached to both rocker links of the central four bar linkage and to both additional rocker links so that there is a pair of circular means on one side of the linkage and another pair on the other side. The flexible pulling and holding means are connected to the circular means so that on both additional rocker link circular means the flexible means contact the circular means on the same side. The flexible pulling and holding means then cross to contact both connected rocker link circular means on their same sides which are the opposites to those of the additional rocker link circular means. This configuration of single belts provides the required moving and holding actions. This configuration can also be described as moving one layer of circular means and belts from one side of the rocker linkage to the other side of the rocker linkage with the required functions still occurring.

FIG. 3 represents an embodiment in which the coupler link is used as a base (i) providing for a mechanism that allows and enables straight line movement in the direction indicated by arrow line (ii) with the straight line (iii) passing through the centre of the pivot of the free end of the additional link and through the centre points of the coupler link pivots.

FIG. 3 show an embodiment used to produce straight line point motion. Such an apparatus is useful when straight line motion is required without parallel plane motion. An example of such motion would be the application of a circular cutter or blade rotated concentrically at the free end pivot point. In this embodiment the coupler link is used as a fixed base mount with the ground link being able to move. The parallelogram linkages keep the ground link parallel with the base as it moves. The crossed pulling and holding means keep the relative angle of the connected rocker link and the additional rocker link even and congruent. The free pivot point of the additional rocker link travel in a straight line along a line that includes the two centre points of the coupler link pivots. Such mechanisms could be duplicated and opposed and spaced apart so that a work platform is connected to the additional link pivots and is supported by both sets of pivots so that the work platform travels in a straight line and along a parallel plane.

FIG. 3 shows the single point straight line device with an extended ground link to support the additional rocker link. The same motion and a similarly acting device can be created by mounting the additional rocker link concentrically with one of the linkage rocker links and connecting that additional rocker link and the other rocker link with circular and crossed pulling and holding means as is shown in FIG. 1b.

FIG. 4 represents an embodiment in which the coupler link is used as a base (i) providing for a mechanism that allows and enables straight line and parallel path movement in the direction of arrows (ii) with the extended ground link (iii) and the additional rocker link (iv) having additional coupler link (v) added to form a further four bar linkage and in which the added coupler link is used as the base for the moveable work head with line (vi) representing the straight line and parallel plane passing through the centres of the coupler link pivots that form the base and the moveable workhead of the apparatus and with line (ix) representing an indicative position a push and pull means could be mounted to move and position the workhead and with lines (viii) and (vi) showing an axis or centre point indicated by arrow arc (vii) around which the base can be made to pivot.

FIG. 4 shows a further embodiment apparatus in which a workhead can travel in a straight line and a parallel plane. In this embodiment the coupler link is used as a fixed base mount with the ground link being able to move. The base mechanism has the ground link extended so that an added rocker link is mounted next to the additional connected rocker link. The additional rocker link and the added link are connected by a further coupler link to form two parallelogram four bar linkages.

The connected rocker link of one linkage is connected to the additional rocker link of the other linkage by the circular means and the crossed pulling and holding means, and by the common extended ground link. In this embodiment the base coupler link is held parallel to the extended ground link and the further coupler link is held parallel to the extended ground link.

The circular and crossed pulling and holding means keep the moveable further coupler link level and on the same plane to create and enable the straight line and parallel plane motion and movement. The straight line and the plane in which the coupler link workhead travels include the centre points of both the base coupler link pivots and the workhead coupler link pivots. The described apparatus can be arranged in multiples and various orientations and configurations and can be used to enable travel and movement in the vertical direction for such uses as lifting.

FIG. 4 shows the parallel plane device with an extended ground link to support the additional rocker link. The same motion and a similarly acting device can be created by mounting the additional rocker link concentrically with one of the linkage rocker links and connecting that additional rocker link and the other rocker link with circular and crossed pulling and holding means as is shown in FIG. 1b. Another rocker link is added at the other rocker links ground link pivot point. The added rocker link's free end, and the additional rocker link's free end, are connected with an additional coupler link so that the device has two interconnected four bar linkages.

FIG. 5a represents a further embodiment with the ground link (i) with two connected linkages forming the base and in which additional rocker links are connect at the coupler link pivots (ii) with an extended ground link (iii) added so as to form two additional connected four bar linkages (iv) and which is able to be worked to move extended ground link (iii) in the directions of the arrow being a direction parallel in plane to the base ground link (i) and with line (iv) representing the straight line that passes through the centres of the coupler link pivots with the pivot links remaining in a straight line throughout the movement limits.

FIG. 5a represents a further embodiment in which the ground link forms the fixed base mount and in which two parallelogram planar four bar linkages are mounted on the ground link. For this embodiment one of the adjoining rocker links of each linkage is called the additional rocker link and the other adjoining rocker link is called the connected rocker link. The two linkages are connected by circular means fitted to each link and by crossed pulling and holding means connected to the circular means. In this configuration, when one coupler link is mover in one direction the other coupler link moves in the other direction. When one coupler link is held, the other coupler link is held in the same relative position. At all positions of movement, the centres of the pivots of each of the coupler links remain in a straight line.

In a preferred embodiment of the current embodiment the ground link is long, and the planar linkages are separated so that the ground link forms a wide and stable base. A further two rocker links are added concentrically to the pivot points of each of the two coupler links. An additional extended ground link is added so that four parallelogram four bar linkages are created. The four linkages have a single common extended ground link as a base, two separated coupler links what are common to two of the planar linkages and a common top extended ground link. All links are spaced and distanced so that each of the four bar planer linkages act as a parallelogram four bar linkage. When one of the links is moved all links move and the top ground link moves parallel to the bottom or base ground link. The top ground link can be used as a workhead or platform.

While the opposing angles shown in 5a and 5b are obtuse angles, the embodiments shown can be configured so that opposing angles are acute angle. This can apply to other embodiments as is required and applicable.

FIG. 5b represents an extended embodiment to that shown in FIG. 5a in which the device shown in 5a is duplicated on top of its top ground link with that link being a common link (i) and in which rocker links (ii) and (iii) are fitted with circular means and pulling and holding means that do not cross (iv) so that when rocker link (iii) moves or is held, rocker link (ii) moves or is held accordingly, with at all times rocker link (ii) being parallel to rocker link (iii) and with all linkages moving accordingly, and in which ground link (i) moves parallel to ground link (v) and ground link (vi), and in which any number of devices can be added with crossed pulling and holding means or uncrossed pulling and holding means as is required and practical.

FIG. 5b shows an extended embodiment to that shown in FIG. 5a in which the original linkage system shown is duplicated and could be multiplied by any number and where the duplicate shown is placed on top of the linkage system shown. The top ground link of the original linkage system is made common to the base ground link of the duplicate so that on the common ground link the rocker link pivots of the original are concentric with the rocker link pivots of the duplicate system. Rocker links that are referred to as the additional rocker link and the connected rocker links are fitted with circular means and pulling and holding means that do not cross with one side of the pulling and holding means connecting with the original additional rocker links and the uncrossed pulling and holding means connecting with the circular means connected with the duplicate connected rocker link.

This connection and associated configuration operates and acts so that when the original additional rocker link moves the duplicate connected rocker link also moves so that the original link and the duplicate link always remain and stay parallel to each other. Apart from the ground link base, when one part of the described embodiment apparatus moves or is held, all parts of the apparatus move or are held with the base ground link held parallel to the top platform or workhead link. Additional duplicates can be added to the apparatus as required. Crossed pulling and holding means can be added as necessary.

FIG. 5b is also used to show that apparatuses and machines can include springs and other energy absorbing, storing or releasing devices such as mechanical springs or gas springs and other compression and expansions means. Line (vii) indicate as example location that a spring or means could mounted. In this example position an expansion spring would absorb or release energy when work platform (vi) is moved.

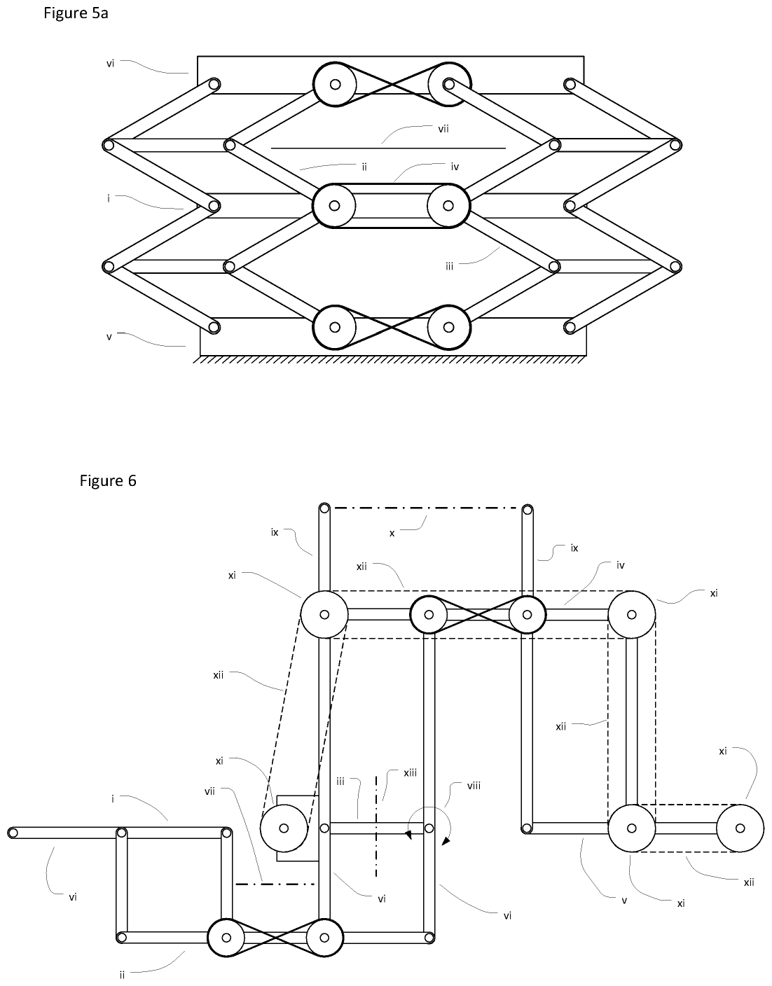

FIG. 6 represents examples of extensions and variation that can be made relative to FIG. 4 embodiments where either link (i) or link (ii) or (iii) or (iv) could become the fixed base to enable or create different movement characteristics, shows how links could be extended (vi) past example bases (i) and (iii) to carry such things as a counterweight or to be a part of a further mechanism or mechanisms according to the invention and with line (vii) representing a place a drive could be positioned, circular line with arrow (viii) indicating another drive position and alternate drive means and line (x) indicating a further drive position on extended links (ix).

FIG. 6 represents examples of extensions and variation that can be made relative to FIG. 4 embodiments and that may be applied to other embodiments and apparatus configurations. The figure can be used to demonstrate that any of the coupler links or any of the extended ground links can become the fixed base to enable or create different movement characteristics. The figure shows how links can be extended and used to move and position and shows how rocker links can be extended past the base or coupler or grounds links to carry such things as a counterweight or to be a part of a further mechanism or mechanisms according to the invention.

FIG. 6 is also used to show how additional circular or pivot transfer means that are concentric with link pivots and that can rotate and pivot independently of the links, can be used to transmit power, control, or movement between chosen or selected consecutive links with (xi) showing circular or pivot means transferring motion concentrically from a drive means to and through additional circular means. Due to the concentric nature of the transfer means, movement of the links does not impact upon motion of the links as the transfer means move and rotate independently relative to the pivots. Transfer means (xii) can include belts, ropes, wires, chains, cables, bands or any suitable flexible means. For certain types of motion transfer that does not require full circular motion and only partial rotation, rods could be attached to the circular means or the pivot means so that rods could push and pull on connected circular means or pivot means to allow and cause and enable the transfer of movement with a restricted range of travel. Motion can be transferred for such purposes as to move and operate attachments or to drive and power items such as a circular saw.

Movement and positioning of the mechanism and holding by the mechanism or an apparatus can be generated and effected in different ways. Mechanisms and apparatuses that accord with the invention are suited to control by computers. Computers can be linked to the internet, or an intranet, as required. Computers can also be used to measure, record and transmit as relates to the operation of a mechanism or machine.

FIG. 6 shows at lines (vii), (viii) and (xi) indicative location positions for a means for moving and positioning and of responding to the moving and positioning of the apparatus and workhead when mounting base (iii) is used. Moving and positioning and responding means could include pushing, pulling and holding carried out by and on linear actuators, ball screws with stepper motors, hydraulic or pneumatic cylinders, rack and pinion drives and the like. All moving and positioning and responding means can be computer controlled as required. An advantage of the indicative positions shown is that shorter screws or actuators or rams can be used as the movement distance is multiplied by the mechanism acting relative to the lever principle. FIG. 4 at (vii) also shows an indicative location for a pushing and pulling means to move and position the associated workhead.

Mechanisms, devices and machines that accord with the present invention can be used as motion amplifiers and diminishers and accelerators or launchers. By way of example, motion or movement applied at a position such as (i) relative to coupler link (iii) used as a base is amplified at coupler link position (v). Conversely, motion or movement applied at (v) reduces at (i). Mechanisms and devices can be multiplied and connected to provide added amplification. Guides can be added as necessary.

FIG. 6 shows at circular arrow (viii) an indicative pivot at which the pivot and or the link could be rotated to create and effect the movement and positioning. Rotating means could be a worm drive gear box with the output shaft driving the pivot or pivot shaft or circular means or could be a linear means such as a ball screw and pivot acting on a link or an additional lever fitted concentrically with a pivot. As required, the worm drive could be driven by a stepper motor or other controllable indexing means to provide for accurate control of movement and positioning.

FIG. 6 can be used to show and refer to further embodiments and applications. By way of example of the embodiment, if shared rocker link (iii) is used as the base mount and (v) used as the travelling workhead, the base mount could be fitted with a turntable or bearings to enable the mechanism to rotate around the indicative axis shown by line (xiii) so that the apparatus could rotate through 360 degrees to enable moving and shifting to required and accessible locations to be aligned as required. This axis of rotation can be defined as being at right angles to the plane of travel of the workhead. The axis could also be moved towards or away from the workhead to provide for different movement and balance characteristics.

A related embodiment is shown relative to FIG. 4 which is used to show and refer to this further embodiment and application. Coupler link base (i) is fitted with a pivot means or rotation means to enable the mechanism to rotate and angle as shown by the arrow arc (vii) around the indicative axis shown by crossed lines (vi) and (viii) so that the apparatus is able to elevate to enable and allow the work head to mechanism to tilt and move down and up from the horizontal to the vertical and to be adjusted to angles between. This axis of rotation or pivot axis can be defined as being parallel to the plane of travel of the workhead. The alignment and orientation of the FIG. 4 device and other embodiments can be changed so that the shown pivot is vertical and so that the plane of travel of the workhead is vertical with the FIG. 4 view, or another figure viewed, becoming a top or plan view.

In a further embodiment that can be described relative to FIGS. 4 and 6 and way of example to describe the embodiment, each base mount could be fitted with a moving mechanism that accords with the present invention to move the entire mechanism up and down vertically so that each workhead moves accordingly vertically up or down. Alternatively, workheads can be fitted with or mounted with a separate mechanism or mechanisms that accord with the current invention and embodiments so that separate vertical movement, or movement that is at a right angle to the plane of travel of the workhead movement, or at another required angle, is created and enabled.

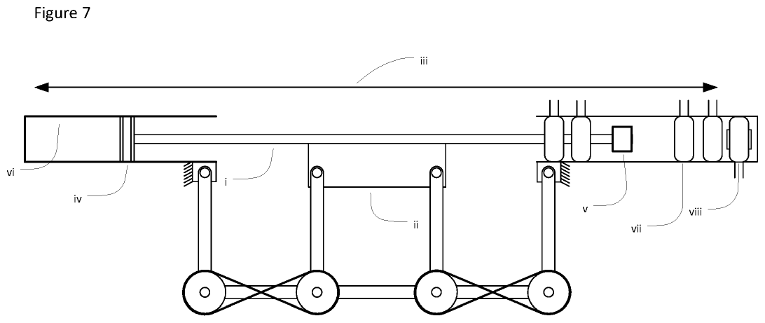

FIG. 7 represents uses for embodiments of the invention with the embodiment relating to the embodiment shown in FIGS. 2 with (i) being a rod or shaft connected to coupler link workhead (ii) with the rod travelling in the straight line and parallel plane indicated by double ended arrow (iii) with the rod at one end being fitted with a piston (iv) and at the other end a permanent magnet (v) and with the mount frame being fitted with a cylinder (vi) in which the piston travels and at the other end wiring (vii) loops in which the magnet travels and an electro magnet (viii) which just clears the permanent magnet at the end of its travel.

Indicative example use embodiments are given in FIG. 7 with the uses relating to the embodiment shown in FIGS. 2. A rod or shaft is connected to the coupler link workhead with the rod travelling in a straight line and parallel plane. One end of the traveling rod is fitted with a piston. The other end of the rod is fitted with a permanent magnet. The mount frame is fitted with a cylinder in which the piston travels.

At the other end wire loops are fitted to the mount frame so that the magnet travels in the loops. An electromagnet can be also mounted on the frame so that the rod mounted permanent magnet approaches and comes close to the electromagnet at the end of its travel. The piston and cylinder can be used to drive the rod backwards and forwards and the electrical related means can be used to generate electricity. Conversely, the electrical means could be used to utilise provided electricity to move the piston. A connecting rod and crankshaft or flywheel can be fitted as necessary.

An apparatus incorporating one or more pistons and cylinders could be used as an internal combustion engine, a heat engine such as a Stirling engine, a steam engine, a compressed air engine, a water engine or as a fluid or gas or air pump or compressor.

The shown configuration of mounting the piston, cylinder and electrical means is not intended to limit the ways in which such items are configured or arranged, or to limit the range or type of items that could be attached and used by different apparatuses and machines that accord with the present invention.

Drawings show side views and a single layer or plane of links, pivots, circular means and pulling and holding means.

Any number of links or multiples of links can be used relative to each link shown. Links can be mounted with rods or axles or shafts at the pivot points so that multiples of the same link can be spaced as required and so that other links, such as a rocker link and a ground link can be mounted next to each other on the shaft so that pivots remain concentric and so that the four bar linkage can function as a four bar linkage.

Links and links with attached circular means can be fixed relative to the shafts, or the links and links with attached circular means can have bearings, bushes or be plain holes so that they can rotate independently of the shafts. Shafts can be used to transmit motion and force between links and other links and or circular means mounted on the same pivot point shaft. A connected rocker link could be connected by way of the circular means being connected to the shaft with the rocker link also being connected to the shaft. A link can be made of any material and in any configuration that allows the range of movement required and that has suitable strength and stiffness and that can take the required fasteners and fixings and provide the required support for the bearings, bushes or plain pivot holes.

Any number of circular means and flexible pulling and holding means can be used relative to each circular and pulling and holding means shown. Circular means and pulling and holding means can be multiplied at any particular pivot point as required for the purpose of strength and stability. Part circular means could be used if contact with the circumference of the circular means and the constant tangential distance between the part circular means can be maintained throughout the required movement range of the linkage and mechanism. Circular means can be adjusted relative to links to ensure that the crossed pulling and holding means hold the links at the required angle and in the required position. At a base level, slots can be made in the circular means so that the circular means can be rotated relative to the links with bolts being used to hold the circular means in the required position. Circular means can include adjusting means for the pulling and holding means. Alternatively, the crossed pulling and holding means can be adjusted using tensioners and adjusters mounting between the circular means and acting directly on the pulling and holding means so that the pulling and holding means can be adjusted in length and for tension. Pulling and holding means could be roller chains, belts, bands, link chains, wire, rope or the like.

Embodiments are not limited to those described in this description.

This description and its associated drawings are not intended to indicate or imply relative to size or scope of potential applications for the current invention. Available literature shows parallelogram linkages used in applications ranging from surgical procedures to heavy industry.

What is claimed is:

1. A mechanism that forms part of a device, apparatus or machine that incorporates a parallelogram four bar linkage with a ground link that can be extended as required to mount at least one additional pivotable rocker link, with that additional rocker link and one of the four bar linkage rocker links having concentric circular means attached at their ground link pivot points, with those circular means connected with crossed flexible pulling and holding means, so that when one connected rocker link is held, the other connected rocker link is held in the same relative position, and when one connected rocker link is moved in a direction, the other link moves in the opposite direction, with the four bar linkage moving and being held accordingly, and with the additional rocker link adjusted and angled so that during the full length of travel of the additional rocker link in that opposite direction, the free top pivot point of the additional rocker link remains in line with a straight line formed by the coupler link pivot points.

2. A device, apparatus or machine according to Claim 1 in which the additional rocker link is connected to the ground link concentrically with one of the four bar linkages rocker links, with the other rocker link of the four bar linkage and the additional rocker link fitted with circular means, with both circular means connected by crossed pulling and holding means, with another rocker link being added to the ground link concentrically with the other connected rocker link, with an additional coupler link being added to the free ends of the additional and added rocker links to form a further four bar linkage, with the original four bar linkage and the added four bar linkage having a common ground link, and with the original rocker link being used as a fixed mounting base so that the ground link can move, and so the additional coupler link moves in a straight line and along a parallel plane along the length of its travel.

3. A device, apparatus or machine incorporating the mechanism of claim 1 in which the ground link is extended on either side of the four bar linkage and in which at least two additional rocker links are added to the ground link, one or more each side of the linkage, with circular means being attached to one or both linkage rocker links close to the four bar linkage and to one or both additional rocker links so that at least one additional rocker link circular means is connected to the circular means attached to the linkage rocker link, with crossed flexible pulling and holding means connected to the circular means, and with the free pivot ends of the additional rocker links being supported by a frame support so that the ground link can swing between the supports and so the coupler link travels in a straight line and along a plane that includes the supported additional rocker link pivot centres and the centres of the coupler link pivots.

4. A device, apparatus or machine that accords with claim 3 in which both additional rocker links that are next to each of the linkage rocker links and both the linkage rocker links have circular means attached with one flexible crossed pulling and holding means being connected to the circular means on one side of the linkage and another single crossed pulling and holding means connected to the circular means on the other side of the linkage so that both single crossed pulling and holding means combine to move and hold in the way defined by claim 1.

5. A device, apparatus or machine that accords with claim 1 in which one additional rocker link is connected so as to form the mechanism and in which the coupler link is used as the fixed base mount and in which movement of the mechanism causes the centre of the free end pivot of the additional rocker link to move in a straight line that includes the points that are the centres of the fixed base mount coupler link pivots.

6. A device, apparatus or machine that accords with claim 1 and in which the coupler link is used as the fixed base mount and two additional rocker links are connected and another coupler link is added between the free ends of the additional rocker links so that another parallelogram four bar planar linkage is added to the apparatus or machine and so that when the added coupler link moves it moves in line with and along the same plane as the line and plane formed by the centres of the fixed base mount coupler link pivots.

7. A device that accords with claim 1 in which two additional rocker links are connected and another coupler link is added between the free ends of the additional rocker links so that another parallelogram four bar planar linkage is added to the mechanism, and with the extended ground link being used as the fixed mount base so that when the added coupler link moves both coupler links are parallel and remain parallel throughout the range of their movements with the parallel plane formed by the coupler links being parallel to the ground link used as the fixed mount base.

8. An apparatus or machine according to Claims 1 to 7 in which one or more than one mechanism or apparatus is utilised in a further apparatus or machine, and in which the mechanisms or apparatuses are any of positioned, orientated, configured, aligned and multiplied in a required way.

9. An apparatus or machine that accords with claims 1 to 8 that incorporates circular means and flexible pulling and holding means that are not crossed so that at least one link used in an apparatus or machine is connected by circular means and the flexible pulling and holding means to another link with circular means so that when one link is held the other connected link is held in the same relative parallel position and so that when one connected link moves the other connected link moves parallel to the other connected link.

10. A mechanism apparatus or machine according with claims 1 to 9 in which rocker links or coupler links are extend as required to allow the connection of counterweights, to facilitate moving, positioning, holding and measuring, and to allow the further incorporation of mechanisms and apparatuses.

11. A device, apparatus or machine that accords with claims 1 to 10 in which the ground link or the rocker link is used as a workhead or work platform and in which as required an additional mechanism or apparatus embodiment provides for travel of at least one additional workhead along a plane or line at right angles or at other angles to the plane of travel of the work head or work platform on which it is based.

12. A device, apparatus or machine that accords with claims 1 to 11 in which a coupler link or a ground link used as a fixed base mount is fitted with a turntable or bearings or rotation means to enable the mechanism to rotate around an axis defined as being at right angles to the plane of travel of the workhead or work platform.

13. A device, apparatus or machine that accords with claims 1 to 12 in which a coupler link or a ground link used as a fixed base mount is fitted with a pivoting means that enables the mechanism to tilt and move down and up from the horizontal to the vertical around an axis defined as being parallel to the plane of travel of the workhead or work platform.

14. A device, apparatus or machine according with claims 1 to 13 in which, and as required, and in a way required, a mechanism is moved, held and positioned by use of rotational means or pulling and pushing means.

15. A device, apparatus or machine according with claims 1 to 14 that incorporates as required one or more sets of a piston and cylinder, electrical generating and utilising means such as magnets and coils and a connecting rod and crankshaft or flywheel.

16. A device, apparatus or machine according with Claims 1 to 15 in which, as required, moving, holding positioning, measuring and recording is controlled or aided by computing and computers and in which those computers are connected to the internet or an intranet as required.

17. A mechanism apparatus or machine according with claims 1 to 16 which incorporates springs and compression and expansion means and energy absorbing, storing and releasing means.

18. A device, apparatus or machine that accords with claims 1 to 17 which incorporates additional circular or pivot means that are concentric with link pivots, and that can rotate or pivot independently of the links, and which are linked to each other by flexible means that allow and cause full circular movement and rotation of connected circular means, or by rods which allow and cause partial rotation and movement of a connected circular or pivot means.

19. A mechanism apparatus or machine according with claims 1 to 18 in which, and as required, each link is multiple in number and mounted on extending pivot point shafts, axles or rods, with pivots being bearing, bushes or plain holes, with links being any material with suitable qualities, with circular means being plates, wheels or sprockets, with flexible pulling and holding means being chains, ropes, belts and bands, each circular means is multiple in number, each flexible pulling and holding means is multiple in number, with circular means being adjustable relative to attached links, and with pulling and holding means being adjustable for length.

20. The use of the mechanisms, devices, apparatuses and machines that accord with Claims 1 to 19.
